(19) United States
(12) Patent Application Publication
(10) Pub. No.: US 2019/0228475 A1
(43) Pub. Date: Jul. 25, 2019

(54) SYSTEM AND METHOD FOR OPTIMIZING REISSUANCE OF ELECTRONIC DOCUMENTS

(71) Applicant: Vatbox, Ltd., Herzeliya (IL)

(72) Inventors: Noam Guzman, Ramat Hasharon (IL); Isaac Saft, Kfar Neter (IL)

(73) Assignee: Vatbox, Ltd., Herzeliya (IL)

(21) Appl. No.: 16/375,524

(22) Filed: Apr. 4, 2019

Related U.S. Application Data
(63) Continuation of application No. PCT/US2018/013487, filed on Jan. 12, 2018.
(60) Provisional application No. 62/445,246, filed on Jan. 12, 2017.

(51) Int. Cl. G06Q 40/00; G06F 16/93; G06K 9/46

(52) U.S. Cl. CPC G06Q 40/123; G06K 2209/01; G06K 9/46; G06F 16/93

(57) ABSTRACT

A system and method for optimizing a request to reissue an electronic document. The electronic document includes at least partially unstructured data. The method includes analyzing the electronic document to determine at least one transaction parameter; creating a template for the electronic document, wherein the template is a structured dataset including the determined at least one transaction parameter; determining, based on the template, whether the electronic document meets at least one evidencing requirement; determining at least one optimization parameter based on historical reissuance data when it is determined that the electronic document does not meet the at least one evidencing requirement; and sending an optimized reissuance request based on the determined at least one optimization parameter.

### CROSS-REFERENCE TO RELATED APPLICATIONS

This application is a continuation of International Application PCT/US2018/013487 filed on Jan. 12, 2018, which claims the benefit of U.S. Provisional Application No. 62/445,246 filed on Jan. 12, 2017.

The contents of the above-referenced applications are hereby incorporated by reference.

### TECHNICAL FIELD

The present disclosure relates generally to requesting reissuance of electronic documents, and more particularly to optimizing requests for reissuance of unstructured electronic documents.

### BACKGROUND

Enterprises all over the world usually spend large amounts of money on goods and services purchased by the enterprises' employees in the course of regular business. Portions of these transactions may be refundable such that, for example, the enterprise can reclaim the value added tax (VAT) or deduct qualified expenses from the corporate income tax (CIT). Such expenses should be reported to the tax authorities in order to reclaim at least a partial tax refund for the expenses made.

The VAT is a consumption tax paid on purchases of products in certain countries that is based on the increases in value of the purchased product at each stage of its production or distribution. VATs paid on some types of goods may be refunded depending on the jurisdiction in which the purchase is made. The CIT is a tax on the profits of corporations in the United States of America that is equal to a corporation's receipts less allowable deductions for ordinary and necessary expenses, such as cost of goods sold, wages and other employee compensation, interest, certain taxes, transportation expenses, depreciation of certain assets, and advertising costs.

In many cases, to obtain a refund or deduction, the enterprise is required to provide evidences such as receipts, invoices, and the like, associated with the expenses made. These evidences may need to be submitted along with a statement of the relevant parameters for the transaction such as date, time, types of goods purchased, and the like. A report including the evidences and any necessary statements is prepared and provided to appropriate tax authorities to obtain the refund.

In order to get the full tax benefit for business expenses, the evidences which prove transactions must include certain elements that may be different from one jurisdiction to another. Therefore, in case an evidence does not includes a necessary element, the evidence cannot be used for a successful refund or deduction.

Currently, when a necessary element is missing from one or more evidences, e.g. receipts, a request to reissue the evidence is sent to an entity (e.g., a supplier of goods) that originally issued the evidence. This request can be time consuming for both the issuing entity and the requesting entity. One popular, however expensive, solution is to hire the services of an accounting firm to handle this important financial matter.

Some solutions exist for automatically managing evidences to ensure compliance with jurisdictional rules. However, these solutions can, at best, send the request to a predetermined recipient which may not efficiently return the reissued document. Further, such solutions may not efficiently or accurately identify missing elements, particularly when the evidences are in the form of unstructured documents such as scans of receipts or invoices.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for optimizing a request to reissue an electronic document including at least partially unstructured data. The method comprises: analyzing the electronic document to determine at least one transaction parameter; creating a template for the electronic document, wherein the template is a structured dataset including the determined at least one transaction parameter; determining, based on the template, whether the electronic document meets at least one evidencing requirement; determining at least one optimization parameter based on historical reissuance data when it is determined that the electronic document does not meet the at least one evidencing requirement; and sending an optimized reissuance request based on the determined at least one optimization parameter.

Certain embodiments disclosed herein also include a non-transitory computer readable medium having stored thereon causing a processing circuitry to execute a process, the process comprising: analyzing an electronic document to determine at least one transaction parameter, wherein the electronic document includes at least partially unstructured data; creating a template for the electronic document, wherein the template is a structured dataset including the determined at least one transaction parameter; determining, based on the template, whether the electronic document meets at least one evidencing requirement; determining at least one optimization parameter based on historical reissuance data when it is determined that the electronic document does not meet the at least one evidencing requirement; and sending an optimized reissuance request based on the determined at least one optimization parameter.

Certain embodiments disclosed herein also include a system for optimizing a request to reissue an electronic document including at least partially unstructured data. The system comprises: a processing circuitry; and a memory, the memory containing instructions that, when executed by the processing circuitry, configure the system to: analyze the electronic document to determine at least one transaction parameter; create a template for the electronic document, wherein the template is a structured dataset including the determined at least one transaction parameter; determine, based on the template, whether the electronic document meets at least one evidencing requirement; determine at least one optimization parameter based on historical reissuance data when it is determined that the electronic document does not meet the at least one evidencing requirement; and send an optimized reissuance request based on the determined at least one optimization parameter.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a reissue optimizer according to an embodiment.

FIG. 3 is a flowchart illustrating a method for optimizing reissuance of electronic documents according to an embodiment.

FIG. 4 is a flowchart illustrating a method for creating a structured dataset template based on an electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for optimizing reissuance of electronic documents. An evidencing electronic document is analyzed to determine whether the evidencing electronic document meets one or more evidencing requirements. When it is determined that the electronic document does not meet one or more of the evidencing requirements, a supplier identifier is identified within the electronic document. Based on the supplier identifier, one or more historical reissue requests and corresponding reissue results are retrieved. Based on the historical reissue requests and results, an optimized reissuance request for reissuing the evidencing electronic document is generated and sent to a destination associated with the supplier identifier.

In an embodiment, the evidencing electronic document is an at least partially unstructured document. A template is created based on the at least partially unstructured electronic document. The template is a structured dataset including transaction parameters in the evidencing electronic document, and is created based on key fields and values identified in the evidencing electronic document. The structured dataset template allows for more efficient and accurate processing of transaction parameter data.

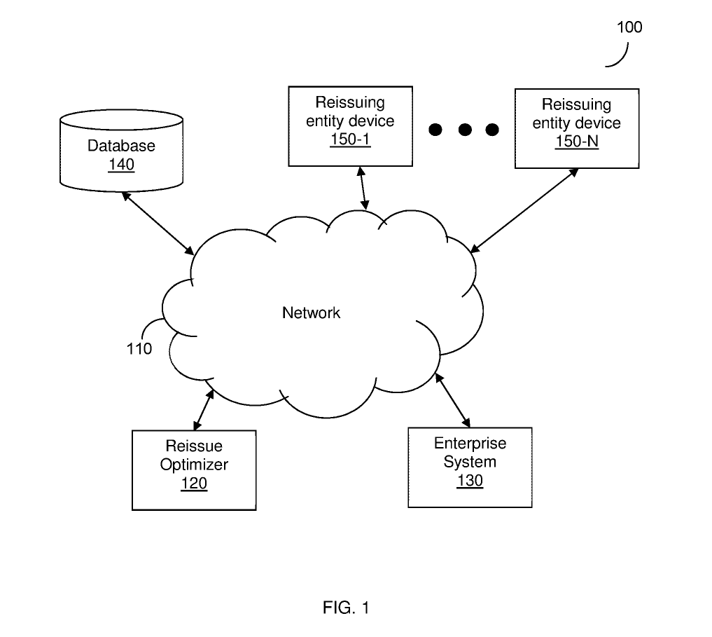

FIG. 1 shows an example network diagram 100 utilized to describe the various disclosed embodiments. In the example network diagram 100, a reissue optimizer 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise system 130 may further store data related to requests (e.g., requests for VAT reclaims or CIT reclaims) to be submitted by the enterprise (e.g., an image file showing a VAT reclaim request form submitted by an employee of the enterprise). The enterprise may be, but is not limited to, a business whose employees may purchase goods and services subject to VAT taxes while abroad, or whose purchases may be eligible for CIT deductions. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, a request for reissuance of an invoice or receipt, etc.). Each electronic document may show, e.g., an invoice, a tax receipt, a purchase number record, a VAT reclaim request, a tax form indicating a CIT deduction, and the like. Data included in each electronic document may be at least partially unstructured, i.e., lacking a known structure, semi-structured, unstructured, or a combination thereof. The structured or semi -structured data may be in a format that is not recognized by the reissue optimizer 120 and, therefore, may be treated as unstructured data.

The database 140 may store data utilized by the reissue optimizer 120 to optimize reissuance of the electronic documents. Such data may include, but is not limited to, templates created based on electronic documents, incomplete reissuance request forms, evidencing requirements, and the like. The evidencing requirements may be further associated with one or more jurisdictions (e.g., one or more countries), uses of evidence (e.g., VAT reclaims, CIT deductions, etc.), a combination thereof, and the like. The evidencing requirements may be retrieved from one or more data sources (not shown), for example, data sources of tax authorities that include rules for requirements of evidencing electronic documents.

The reissuing entity devices 150 are operated by or associated with entities who reissue evidencing electronic documents such as receipts and invoices. As a non-limiting example, the web source 150-1 may be a server of a merchant that keeps records of transactions and creates receipts evidencing the transactions. Requests received by the reissuing entity devices 150 from the reissue optimizer 120 may be responded to by representatives of the respective reissuing entities via the reissuing entity devices. To this end, the reissuing entity devices 150 may be, but are not limited to, a personal computer, a laptop, a tablet computer, a smartphone, a wearable computing device, and the like. In some implementations, the reissuing entity devices 150 may communicate with a reissue entity server (not shown), and be configured to access requests via the reissue entity server.

In an embodiment, the reissue optimizer 120 is configured to create a template based on transaction parameters identified using machine vision of an evidencing electronic document. The evidencing electronic document is an at least partially unstructured electronic document that serves as evidence of a transaction. In a further embodiment, the reissue optimizer 120 may be configured to retrieve the evidencing electronic document from, e.g., the enterprise system 130.

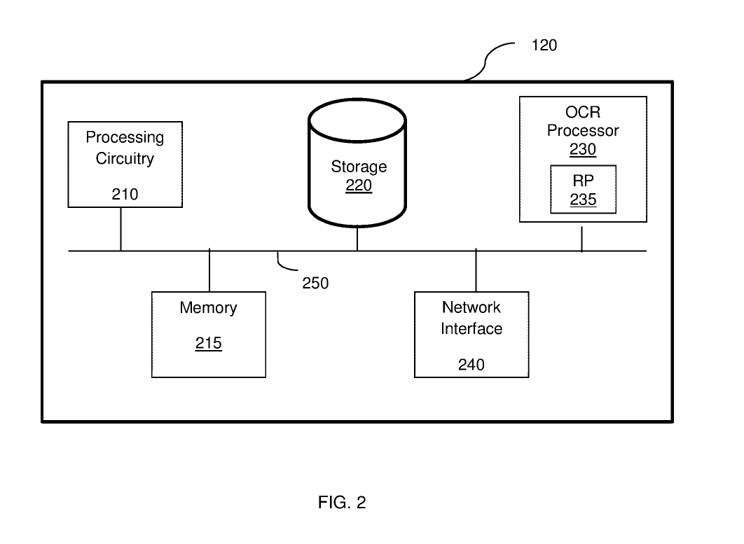

In an embodiment, the reissue optimizer 120 is configured to create structured datasets based on electronic documents including data at least partially lacking a known structure (e.g., unstructured data, semi-structured data, or structured data having an unknown structure). To this end, the reissue optimizer 120 may be further configured to utilize optical character recognition (OCR) or other image processing to determine data in the electronic document. The request verifier may therefore include or be communicatively connected to a recognition processor (e.g., the recognition processor 235, FIG. 2).

In an embodiment, the reissue optimizer 120 is configured to analyze the created structured datasets to identify transaction parameters related to transactions indicated in the electronic documents. In an embodiment, the reissue optimizer 120 is configured to create templates based on the created structured datasets. Each template is a structured dataset including the identified transaction parameters for a transaction.

Using structured templates for determining whether evidencing requirements are met allows for more efficient and accurate determination than, for example, by utilizing unstructured data. Specifically, corresponding evidence requirement rules may be analyzed only with respect to relevant portions of a transaction electronic document (e.g., portions included in specific fields of a structured template), thereby reducing the number of instances of application of each rule as well as reducing false positives due to applying rules to data that is likely unrelated to each rule. Further, data extracted from electronic documents and organized into templates requires less memory than, for example, images of scanned documents.

Based on the created template, the reissue optimizer 120 is configured to determine whether the evidencing electronic document meets one or more evidencing requirements. The evidencing requirements include requirements for types of transaction parameters, values of transaction parameters, or both, and may be requirements for purposes such as, but not limited to, obtaining a refund (e.g., via a VAT reclaim) or a deduction (e.g., a deduction for CITs). The evidencing requirements may be included in sets, where each set is associated with a different use of the evidencing electronic document, jurisdiction in which the transaction occurred, or both. As a non-limiting example, when the evidencing electronic document is to be utilized as evidence to support a CIT deduction, the evidencing requirements may include required transaction parameters for a country of the transaction indicated in the evidencing electronic document.

When it is determined that the evidencing electronic document does not meet the evidencing requirements (e.g., if one or more of the required transaction parameters as defined in the rules is missing), the reissue optimizer 120 is configured to generate and send a request for reissue. In some implementations, the request may be for reissuance of multiple evidencing electronic documents that do not meet appropriate evidencing requirements.

In an embodiment, the reissue optimizer 120 is configured to determine, based on the template, one or more supplier identifiers of a supplier involved in the transaction. Based on the supplier identifiers, the reissue optimizer 120 is configured to retrieve historical reissue data related to the supplier such as, but not limited to, previous reissue requests, results of the reissue requests, or both. The historical reissue data may indicate, for example, a number of reissued electronic documents requested, contents of the reissue request (e.g., information included in the request such as transaction parameters), a destination of the request (e.g., an email address, server, or other physical or virtual address to which the request was sent), a time of the request, a response to a reissue request (e.g., an email including the reissued electronic document), a combination thereof, and the like.

The generated reissue request is optimized with respect to, for example, a time at which the request is to be sent, destination, form of communication to be used (e.g., short message service, email, multimedia message service, etc.), number of reissue requests submitted simultaneously, a combination thereof, and the like, with respect to the identified supplier. Optimizing the request increases the likelihood that the request is successfully responded to and/or decreases the time for response.

For example, the reissue optimizer 120 retrieves historical reclaim data including 10 previous requests for reissuance of electronic documents from a supplier associated with the supplier identification number “12345” indicated in an evidencing electronic document that does not meet one or more evidencing requirements. The previously successful requests (i.e., requests which resulted in a response including the reissued evidencing electronic document) in the historical data include requests that were sent to the email address “reception@hotelname.com” and that the responses to the successful requests were received shortly after 2 AM, the generated request may be sent to the email address “reception@hotelname.com” at 2 AM.

As another example, if previous requests to reissue 5 or more evidencing electronic documents in a single request were not responded to, the generated request may be to reissue the analyzed evidencing electronic document and at most 3 other evidencing electronic documents (i.e., for a total of four or fewer requested reissuances). As yet another example, if previous requests to reissue 5 or more evidencing electronic documents in a single request were responded to 60 or more days after the request was sent but requests to reissue 4 or fewer evidencing electronic documents were responded to within 24 hours, the generated request may be to reissue the analyzed evidencing electronic document and at most 3 other evidencing electronic documents (i.e., for a total of four or fewer requested reissuances).

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the reissue optimizer 120 according to an embodiment. The reissue optimizer 120 includes a processing circuitry 210 coupled to a memory 215, a storage 220, and a network interface 240. In an embodiment, the reissue optimizer 120 may include an optical character recognition (OCR) processor 230. In another embodiment, the components of the reissue optimizer 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, configure the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a structured dataset including key fields and values.

The network interface 240 allows the reissue optimizer 120 to communicate with the enterprise system 130, the database 140, the reissuing entity devices 150, or a combination thereof, for the purpose of, for example, retrieving evidencing electronic documents and evidencing requirements, storing created templates, sending optimized requests, and the like.

It should be understood that the embodiments described herein are not limited to the specific architecture illustrated in FIG. 2, and other architectures may be equally used without departing from the scope of the disclosed embodiments.

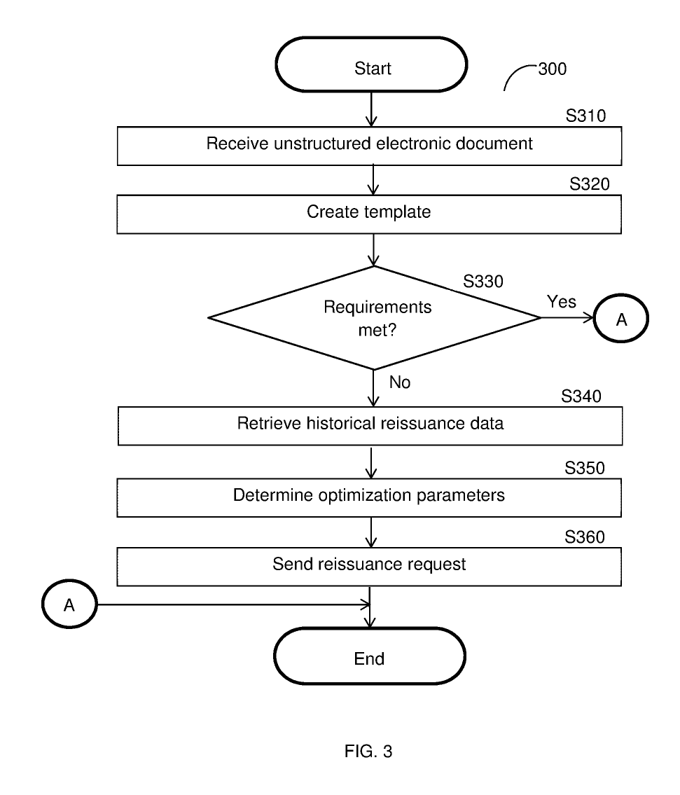

FIG. 3 is an example flowchart 300 illustrating a method for optimizing reissuance of electronic documents according to an embodiment. In an embodiment, the method is performed by the reissue optimizer 120, FIG. 1.

At S310, an evidencing electronic document is received. The evidencing electronic document is at least partially unstructured. In an embodiment, S310 may further include receiving an indication of an intended use for the evidencing electronic document. The intended use may be, for example, to support a CIT deduction or VAT reclaim.

At S320, a template is created based on the received evidencing electronic document.

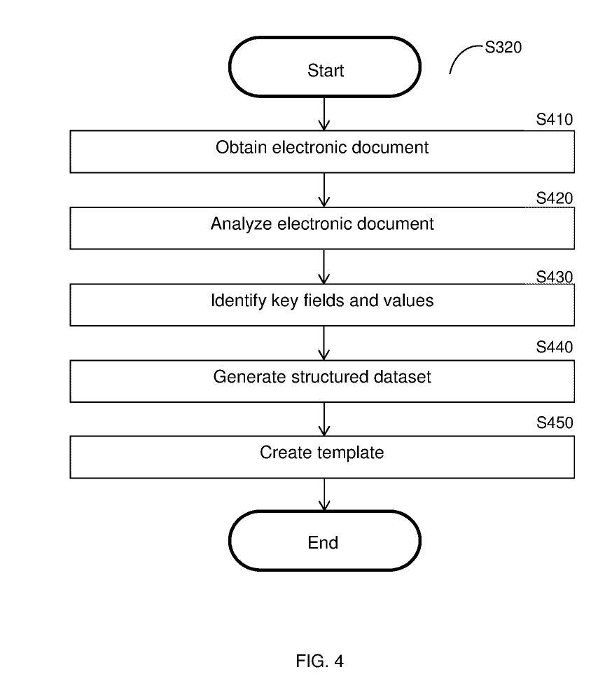

The template is a structured dataset including key fields and values identified in the evidencing electronic document. Creating templates for unstructured electronic documents is described further herein below with respect to FIG. 4 and in U.S. patent application Ser. No. 15/361,934, assigned to the common assignee, the contents of which are hereby incorporated by reference.

At S330, based on the created template, it is determined if the evidencing electronic document meets one or more evidencing requirements and, if so, execution continues with S340; otherwise, execution terminates. The evidencing requirements to be met may be determined based on the intended use, or may be a default set of requirements. The evidencing electronic document may fail to meet an evidencing requirement if, for example, a field of the template corresponding to the evidencing requirement has a null or otherwise invalid value. As a non-limiting example, if the requirements include a price of the transaction and a “price” field of the template has a null value, it may be determined that the evidencing electronic document does not meet the price requirement.

At S340, when it is determined that the evidencing electronic document does not meet the evidencing requirements, historical reissue request data to be utilized for optimizing a reissuance request is retrieved. In an embodiment, S340 includes determining one or more supplier identifiers indicated in the created template and retrieving historical request data of the supplier associated with the supplier identifiers. The historical request data may indicate, for example, a time of each previous request, a time for response to each request, a form of communication of the request (e.g., email, SMS message, MMS message, etc.), a response to the request, a number of evidencing electronic documents requested to be reissued in the request, a destination to which the request was sent, and the like.

At S350, based on the historical request data, one or more optimization parameters for optimizing a reissuance request are determined. The optimization parameters include parameters for increasing likelihood of success of the reissuance request, for decreasing the amount of time for response to the reissuance request, or both. The optimization parameters are determined based on successful requests, i.e., requests that were responded to, and may be determined more specifically based on successful requests that were responded to within, for example, a predetermined time period (e.g., 24 hours).

The optimization parameters include parameters related to, but not limited to, contents of the request, sending of the request, or both. For example, the optimization parameters may include a time for sending the request, a destination to which the request should be sent, a number of evidencing electronic documents for which reissuance should be requested in a single request, information to be included in the request (e.g., missing information determined based on the template and the evidencing requirements), or a combination thereof.

At S360, an optimized reissuance request is generated and sent based on the determined optimization parameters. The optimized reissuance request may be sent to a device of an entity that can reissue the evidencing electronic document, a server associated with such an entity, both, and the like.

FIG. 4 is an example flowchart S320 illustrating a method for creating a structured dataset template based on an electronic document according to an embodiment.

At S410, the electronic document is obtained. Obtaining the electronic document may include, but is not limited to, receiving the evidencing electronic document (e.g., receiving a scanned image) at S310.

At S420, the electronic document is analyzed. The analysis may include, but is not limited to, using optical character recognition (OCR) to determine characters in the electronic document.

At S430, based on the analysis, key fields and values in the electronic document are identified. The key fields may include, but are not limited to, merchant's name and address, date, currency used, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlating to previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated structured dataset includes the identified key fields and values.

At S450, based on the structured dataset, a template is created. The created template is a data structure including a plurality of fields and corresponding values. The corresponding values include transaction parameters identified in the structured dataset. The fields may be predefined.

In an embodiment, creating the template includes analyzing the structured dataset to identify transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the structured dataset may also include identifying the transaction based on the structured dataset.

Creating templates from electronic documents allows for faster processing due to the structured nature of the created templates. For example, query and manipulation operations may be performed more efficiently on structured datasets than on datasets lacking such structure. Further, when organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for optimizing a request to reissue an electronic document, wherein the electronic document includes at least partially unstructured data, comprising:
analyzing the electronic document to determine at least one transaction parameter;
creating a template for the electronic document, wherein the template is a structured dataset including the determined at least one transaction parameter;
determining, based on the template, whether the electronic document meets at least one evidencing requirement;
determining at least one optimization parameter based on historical reissuance data when it is determined that the electronic document does not meet the at least one evidencing requirement; and
sending an optimized reissuance request based on the determined at least one optimization parameter.

2. The method of claim 1, wherein determining the at least one transaction parameter further comprises:
identifying, in the electronic document, at least one key field and at least one value;
creating, based on the electronic document, a structured dataset, wherein the created structured dataset includes the at least one key field and the at least one value; and
analyzing the created structured dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, wherein the electronic document does not meet the at least one evidencing requirement when the template does not include at least one required transaction parameter indicated in the at least one evidencing requirement.

6. The method of claim 1, wherein the at least one optimization parameter includes at least one of: a time for sending the optimized reissuance request, a maximum number of electronic documents to be reissued with respect to the optimized reissuance request, and a destination.

7. The method off claim 1, wherein the at least one optimization parameter is determined based on an intended use of the electronic document.

8. The method of claim 7, wherein the intended use is at least one of: evidence for a value-added tax (VAT) reclaim, and evidence for a corporate income tax (CIT) deduction.

9. The method of claim 1, wherein the electronic document is an image showing at least one of: an invoice, and a receipt.

10. A non-transitory computer readable medium having stored thereon instructions for causing a processing circuitry to perform a process, the process comprising:
analyzing an electronic document to determine at least one transaction parameter, wherein the electronic document includes at least partially unstructured data;
creating a template for the electronic document, wherein the template is a structured dataset including the determined at least one transaction parameter;
determining, based on the template, whether the electronic document meets at least one evidencing requirement;
determining at least one optimization parameter based on historical reissuance data when it is determined that the electronic document does not meet the at least one evidencing requirement; and
sending an optimized reissuance request based on the determined at least one optimization parameter.

11. A system for validating a transaction represented by an electronic document, comprising:
a processing circuitry; and
a memory, the memory containing instructions that, when executed by the processing circuitry, configure the system to:
analyze the electronic document to determine at least one transaction parameter;
create a template for the electronic document, wherein the template is a structured dataset including the determined at least one transaction parameter;
determine, based on the template, whether the electronic document meets at least one evidencing requirement;
determine at least one optimization parameter based on historical reissuance data when it is determined that the electronic document does not meet the at least one evidencing requirement; and
send an optimized reissuance request based on the determined at least one optimization parameter.

12. The system of claim 11, wherein the system is further configured to:
identify, in the electronic document, at least one key field and at least one value;
create, based on the electronic document, a structured dataset, wherein the created structured dataset includes the at least one key field and the at least one value; and
analyze the created structured dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the electronic document.

15. The system of claim 11, wherein the electronic document does not meet the at least one evidencing requirement when the template does not include at least one required transaction parameter indicated in the at least one evidencing requirement.

16. The system of claim 11, wherein the at least one optimization parameter includes at least one of: a time for sending the optimized reissuance request, a maximum number of electronic documents to be reissued with respect to the optimized reissuance request, and a destination.

17. The system off claim 11, wherein the at least one optimization parameter is determined based on an intended use of the electronic document.

18. The system of claim 17, wherein the intended use is at least one of: evidence for a value-added tax (VAT) reclaim, and evidence for a corporate income tax (CIT) deduction.

19. The system of claim 11, wherein the electronic document is an image showing at least one of: an invoice, and a receipt.
